(19) United States
(12) Patent Application Publication
(10) Pub. No.: US 2015/0381610 A1
(43) Pub. Date: Dec. 31, 2015

(54) LOCATION-BASED DATA SECURITY

(71) Applicant: McAfee, Inc., Santa Clara, CA (US)

(72) Inventors: Rajesh Poornachandran, Portland, OR (US); Vincent J. Zimmer, Federal Way, WA (US); Shahrokh Shahidzadeh, Portland, OR (US); Georgios Vassilakes, Brighton (GB); Gopinatth Selvaraje, Portland, OR (US); Sudeep Das, Cupertino, CA (US); Roy Hopkins, Worthing (GB); Christopher S. Gough, Portland, OR (US)

(21) Appl. No.: 14/320,505

(22) Filed: Jun. 30, 2014

(51) Int. Cl. H04L 29/06; H04W 4/00; G06F 21/44; G06F 21/35

(52) U.S. Cl. CPC H04L 63/0853; G06F 21/35; H04W 4/008; G06F 21/44

(57) ABSTRACT

In an example, a system and method are disclosed for location-based security for devices such as portable devices. A portable device may be provided with a short-range transceiver (such as RIFD) that is detectable when a user enters or exits an area. The device may also include an encrypted storage divided into a plurality of discrete units. Upon entering an area, the devices identity and location are provided to a policy server. In response, the policy server may wirelessly provide security tokens to the portable device that enable decryption of specific storage units authorized for access in that area. When a user passes back through a portal to the area, the security tokens are revoked, so that access to secured units of the storage is restricted.

### TECHNICAL FIELD

This application relates to the field of data security, and more particularly to a system and method for location-based data security.

### BACKGROUND

Full-disk encryption (FDE) is a data security method in which a data storage device is completely encrypted to ensure that it cannot be accessed except by authorized persons. In certain examples of existing FDE solutions, an entire physical disk, or an entire “drive” (comprising a separate partition identified by a disk's partition table) is either encrypted or decrypted. In other solutions, individual files may be designated manually by a user to be encrypted.

### BRIEF DESCRIPTION OF THE DRAWINGS

The present disclosure is best understood from the following detailed description when read with the accompanying FIGURES. It is emphasized that, in accordance with the standard practice in the industry, various features are not drawn to scale and are used for illustration purposes only. In fact, the dimensions of the various features may be arbitrarily increased or reduced for clarity of discussion.

FIG. 1A is a plan view of a secure facility according to one or more examples of the present Specification.

FIG. 1B is a diagrammatic view of disk permissions available in a zone of a secure facility according to one or more examples of the present Specification.

FIG. 2A is a plan view of a secure facility according to one or more examples of the present Specification.

FIG. 2B is a diagrammatic view of disk permissions available in a zone of a secure facility according to one or more examples of the present Specification.

FIG. 3A is a plan view of a secure facility according to one or more examples of the present Specification.

FIG. 3B is a diagrammatic view of disk permissions available in a zone of a secure facility according to one or more examples of the present Specification.

FIG. 4A is a plan view of a secure facility according to one or more examples of the present Specification.

FIG. 4B is a diagrammatic view of disk permissions available in a zone of a secure facility according to one or more examples of the present Specification.

FIG. 5 is a network diagram of a secure token exchange according to one or more examples of the present Specification.

FIGS. 6A and 6B are a block diagram of a portable secure computing device according to one or more examples of the present Specification.

FIG. 7 is a block diagram of a policy server according to one or more examples of the present Specification.

FIGS. 8A and 8B are block diagram views of an encrypted storage according to one or more examples of the present Specification.

FIGS. 9A and 9B are a flow chart of a method according to one or more examples of the present Specification.

FIG. 10 is a flow chart of a method according to one or more examples of the present Specification.

FIG. 11 is a flow chart of a method according to one or more examples of the present Specification.

### DETAILED DESCRIPTION OF THE EMBODIMENTS

### Overview

In an example, a system and method are disclosed for location-based security for devices such as portable devices. A portable device may be provided with a short-range transceiver (such as RIFD) that is detectable when a user enters or exits an area. The device may also include an encrypted storage divided into a plurality of discrete units. Upon entering an area, the devices identity and location are provided to a policy server. In response, the policy server may wirelessly provide security tokens to the portable device that enable decryption of specific storage units authorized for access in that area. When a user passes back through a portal to the area, the security tokens are revoked, so that access to secured units of the storage is restricted.

### Embodiments of the Disclosure

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed.

Different embodiments many have different advantages, and no particular advantage is necessarily required of any embodiment.

As enterprise networks become increasingly heterogeneous, traditional methods of full disk encryption encounter novel challenges. For example, many enterprises have moved or are moving at least partly to a “bring your own device” (BYOD) model, wherein users may supply their own equipment, such as desktop computers, laptop computers, smartphones, tablets, and other intelligent computing devices. In a BYOD model, it becomes important for the enterprise to segregate proprietary and or sensitive data from the user's own data. For example, it may be desirable to allow a user to access proprietary or sensitive data on the worksite, but to restrict access to such data off the worksite. It is also desirable to protect devices from data loss as the result of theft, industrial espionage, or disgruntled employees. For example, even an innocent enterprise user may accidentally lose or have stolen from her a portable device containing proprietary or sensitive data, which then leaves the enterprise's sphere of control. This can result in competitive harm or legal exposure. In the case of medical or legal services, client and patient data also present complications. For example, it is beneficial for a medical or legal services provider to have controls and policies in place to ensure that sensitive data are properly controlled and distributed.

In a homogeneous computing environment, these difficulties may be partly alleviated by ensuring that managed devices are uniform and have sufficient encryption, antivirus, and other security features. But this model lacks flexibility that is sometimes desirable. Thus, it is advantageous to provide a system and method that provides real-time, on-demand segregation and encryption of data.

Such a system and method may take the form of dividing a storage device, such as a hard drive, solid-state drive, or similar, into a plurality of “partitions.” It should be noted that the word “partitions” in this context and as used throughout this Specification is intended to broadly encompass any discrete or separately-identifiable portion of a memory or storage, and not necessarily a separately-identified block or slice in a disk's “partition table.” Thus, a partition may represent any discrete region of memory that can be treated separately from other discrete regions of memory for security purposes. A “secure partition” as used throughout this Specification and the appended Claims may include any partition that is capable of being managed according to the devices and methods disclosed in this Specification, and may at various times be either encrypted or unencrypted.

A plurality of partitions may be provided, each with a separate location-based security policy, which provides particular utility in so-called full disk encryption (FDE) schemes. Under certain FDE schemes, either the entire disk must be encrypted and inaccessible, or decrypted and accessible. This may carry the danger of data being accessed at undesirable times and/or places, and of inappropriately intermingling personal data and business data. For example, a non-partitioned FDE scheme may result in a user's personal documents, photographs, and media files being intermingled with policy-driven business data. The business may then need to concern itself with whether pirated, illegal, offensive, or other content against policy has been stored to its servers. Conversely, if an employee can access sensitive data at home, the business must concern itself with industrial espionage, data leaks, breach of confidences, and theft of devices.

By identifying specific partitions of a disk as suitable for containing different classes of data, however, the separate partitions can be individually encrypted and/or decrypted according to a device-enforceable policy.

In one example, one or more facilities are divided into a plurality of zones. A user may operate a portable device, such as a laptop or tablet, containing an encrypted storage divided into a plurality of partitions. As a user moves between areas of the facility, the device may selectively apply time-and-place-driven security policies to the different partitions, and determine whether certain partitions should be encrypted or decrypted by default, whether a user can override that default, and whether a partition should be segregated from corporate or personal networks. The device may encrypt and/or decrypt partitions according to this policy, so that access to certain data is denied in appropriate context, and granted in appropriate contexts.

In one example, stored data may be divided into eight classes: Personal Data, Personal Applications, Non-sensitive Data, Non-Sensitive Applications, Sensitive data, Sensitive Applications, Classified Data, and Classified Applications. Each of these may be stored on a separate partition. These eight partitions with one-to-one mappings to eight data classes are disclosed by way of example only. A practitioner in the art will necessarily design one or more secure partitions that meet the needs of a particular context and application, which may include zero, one, or more of these example partitions, and which may include zero, one, or more additional partitions.

In this example, “personal data” includes personal documents, files, photographs, media, and other non-enterprise data that a user may wish to have access to for personal reasons. Security considerations for personal data may include, for the enterprise, not intermingling personal data with enterprise data, not storing personal data on enterprise servers, not permitting personal data to inject viruses or other malware into the enterprise network, not intermingling personal data with enterprise data on enterprise partitions, and ensuring that enterprise data do not get stored to the personal data partition. For the user, security considerations may include maintaining a reasonable expectation of privacy in personal data.

“Personal applications” may include applications that the user installs herself, such as personal office applications, games, shareware, and open source software. Security considerations for personal applications may include, for the enterprise, ensuring that the enterprise is not responsible for the licensing, maintenance, and support of personal applications, and ensuring that personal applications do not handle enterprise data.

In an example, the six partitions other than “personal data” and “personal applications” may be broadly classified as “enterprise” partitions, with varying levels of sensitivity.

“Non-sensitive data” may include enterprise-generated data that are not business critical or of competitive significance. Nevertheless, it is still desirable to prevent casual, inadvertent, or excessive disclosure of these data. One characteristic of non-sensitive data is that while a particular datum by itself may be harmless, a large compilation of non-sensitive data may be used to infer or interpolate to sensitive enterprise data. Thus, security considerations for non-sensitive data may include ensuring that non-sensitive data are not excessively or casually intermingled with personal data, and that large blocks of non-sensitive data are not casually or easily distributed outside of the enterprise.

“Non-sensitive applications” may include applications that are licensed, provided, and supported by the enterprise, but that are not specially designed to handle enterprise-specific data, and whose use by an employee for non-business purposes may, in general, be considered harmless. Non-sensitive applications may include various commercial off-the-shelf (COTS) software such as Microsoft Office. Security considerations for non-sensitive applications may include ensuring that they are used in accordance with their licenses, and that they are not used to intermingle personal and enterprise data.

“Sensitive data” may include proprietary, competition-sensitive enterprise data, data subject to a non-disclosure agreement (NDA), limited-distribution data (such as non-classified documents with a U.S. government Distribution B, C, D, E, or F statement or equivalent), export-controlled documents, or other documents whose release could cause harm. Sensitive data may also include, for appropriate enterprises such as medical and legal services providers, patient and client confidential data controlled by duties to the client. Security considerations for “sensitive data” include ensuring that sensitive data are not easily intermingled with lower-security classes of data except according to policy, ensuring that sensitive data are not distributed except according to policy, and that sensitive data are wiped from a storage drive if it is lost, stolen, or moved to a location where it is in danger.

“Sensitive applications” may include proprietary or enterprise-customized applications that inherently handle or contain sensitive data. These may include, for example, custom databases, custom web interfaces, enterprise resource planning (ERP) applications, customer relationship management (CRM) software, financial applications, or applications with special licensing provisions. Security considerations for sensitive applications may include, for example, ensuring that they are not operated on uncontrolled machines, ensuring that they are operated in accordance with their licensing restrictions, disabling them when an authorized device is not operated in an authorized area, and protecting them from viruses or contamination from non-enterprise data.

“Classified data” may include data of the highest sensitivity in a given context. This may include, for a non-governmental enterprise, extremely competition-sensitive trade secrets (e.g., the legendary formulas for Coca-Cola or Kentucky Fried Chicken), time-sensitive data whose disclosure could have severe competitive or legal consequences, or for a government enterprise or contractor, governmental data classified as “Secret” or “Top Secret,” or the equivalent. In certain contexts, classified data may only be created, viewed, or manipulated in special “vault” rooms with stringent security properties and procedures. Security considerations for classified data may include ensuring that they are never intermingled with other types of data, never stored on a non-approved device, never taken outside of the vault area in a usable form, never improperly modified or tampered with, and securely wiped from any storage drive if it leaves the designated area.

“Classified applications” may include applications specially modified or designated for handling classified data. Classified applications may include, for example, classified models or simulations that are capable of producing classified data. In certain embodiments, classified applications may have special security provisions that enable them to safely handle classified data. Security considerations for classified applications may include, for example, ensuring that they are not contaminated or intermingled with inappropriate data, ensuring that their operation is not impaired by improper modification, and ensuring that they are securely wiped from a storage device if it is removed from an authorized area.

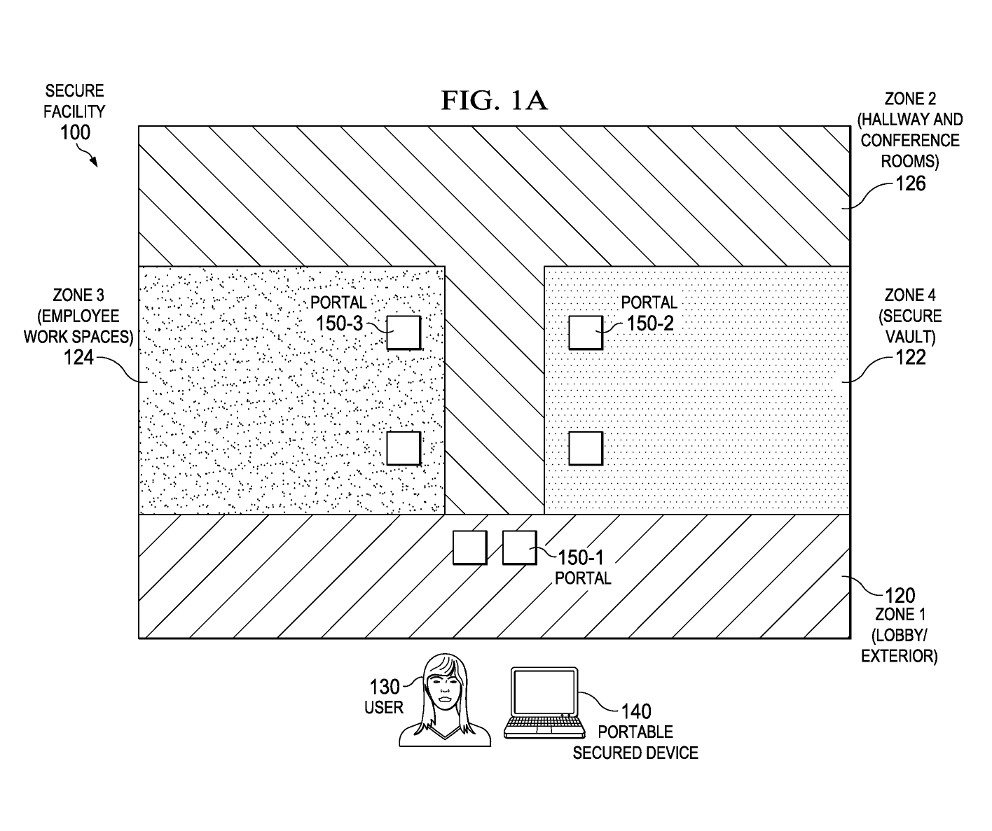

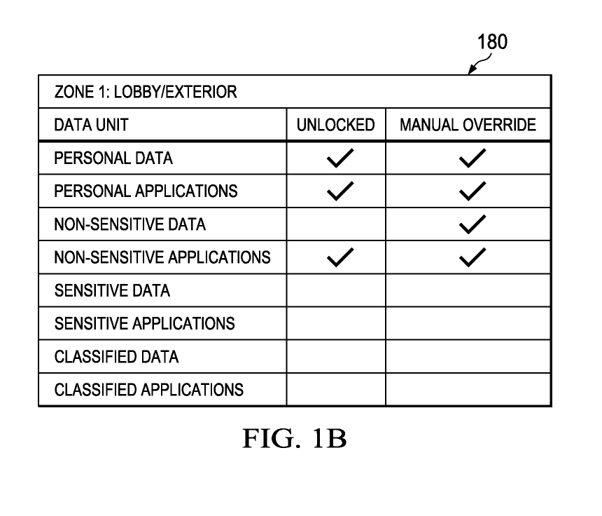

Turning now to the attached FIGURES, FIGS. 1A and 1B provide a plan view of a secure facility and a tabular view of an associated security policy for a particular zone in that facility, according to one or more examples of the present Specification. For purposes of discussion, FIGS. 1A and 1B will be considered jointly.

In the plan view, secure facility 100 may be, for example, a corporate office building with a plurality of discrete zones, each of which has an associated policy. A user 130 operates a portable secured device 140, which may be any suitable portable computing device. It should also be noted that a portable device is shown here by way of example only. The teachings of the present Specification are equally applicable to a device, such as a server or desktop computer by way of non-limiting example, that is not intended to be readily moved, where it is desirable to ensure that the device remains in its designated zone.

In an example, zone 1 120 may include the lobby and exterior of the building. Zone 1 120 may also include in its security policy all areas away from secure facility 100, such as user 130's home. In this example, zone 1 120 represents a zone with relatively weak or no enterprise security properties, where user 130's activities are relatively uninhibited and of low-2-no enterprise value. Thus it is desirable to strictly limit user 130's access to enterprise data in zone 1 120.

Zone 2 126 may include a hallway and conference rooms. In this example, zone 2 126 may represent a region with low-2-intermediate enterprise security properties, and wherein users' activities are somewhat restricted and of enterprise value. However, zone 2 126 may also frequently host non-enterprise actors. Thus, it may be desirable to somewhat limit users' access to enterprise data.

Zone 3 124 may include employee workspaces, such as cubicles and offices. Zone 3 124 may have relatively high enterprise security, and user 130's activities may be highly regulated and of high enterprise value. Non-enterprise actors may visit zone 3 124 infrequently or never. Furthermore, in zone 3, users may need significant access to enterprise data to carry out their work functions. Thus, within zone 3 124, users may be granted more unrestricted access to sensitive data.

Zone 4 122 represents a highly-secure area, such as a secure vault or workroom. Zone 4 122 may be designed to have inherently very high enterprise security. In an example, zone 4 122 is designed specifically for handling classified data and applications. Thus, within zone 4, user 130's legitimate actions are very tightly controlled and solely of enterprise value and security may outweigh convenience. It may also be desirable within zone 4 122 to enforce strict security policies with respect to ingress or egress of other non-cleared actors and data. In an example, non-enterprise actors may never enter zone 4 122, and non-classified data or partitions shall not be accessible within zone 4 122. Thus, the policy for zone 4 122 may require that only classified data be accessible, and that classified data and applications are securely wiped upon egress.

In an example, user 130 starts out in zone 1 120. In an example, secured portable device 140 may default to zone 1 120 settings if its zone cannot be determined. In another example, settings may have been applied when user 130 entered zone 1 with secured portable device 140.

While user 130 is in zone 1 120, security policy 180, shown in FIG. 1B, is applied to portable security device 140. According to security policy 180, within zone 1, personal data, personal applications, and non-sensitive applications are available by default. Each of these is also subject to manual override, meaning that if user 130 chooses to, she may manually provide a token (such as a password, encryption key, or two-factor authentication) to encrypt or decrypt these partitions at will. The non-sensitive data partition is disabled by default, but an override also applies to this. Thus, if user 130 wants to access non-sensitive data, she may provide a token to decrypt it. Security policy 180 may provide that the non-sensitive data partition automatically encrypts itself again after a given time, so that if user 130 wants to access the partition again later, she must again provide the token. This provides a balance between allowing user 130 to access non-sensitive enterprise data in a reasonable manner, while preventing inadvertent or malicious disclosure of large amounts of non-sensitive data. For additional security, each access to the non-sensitive data partition may be logged or otherwise traceable.

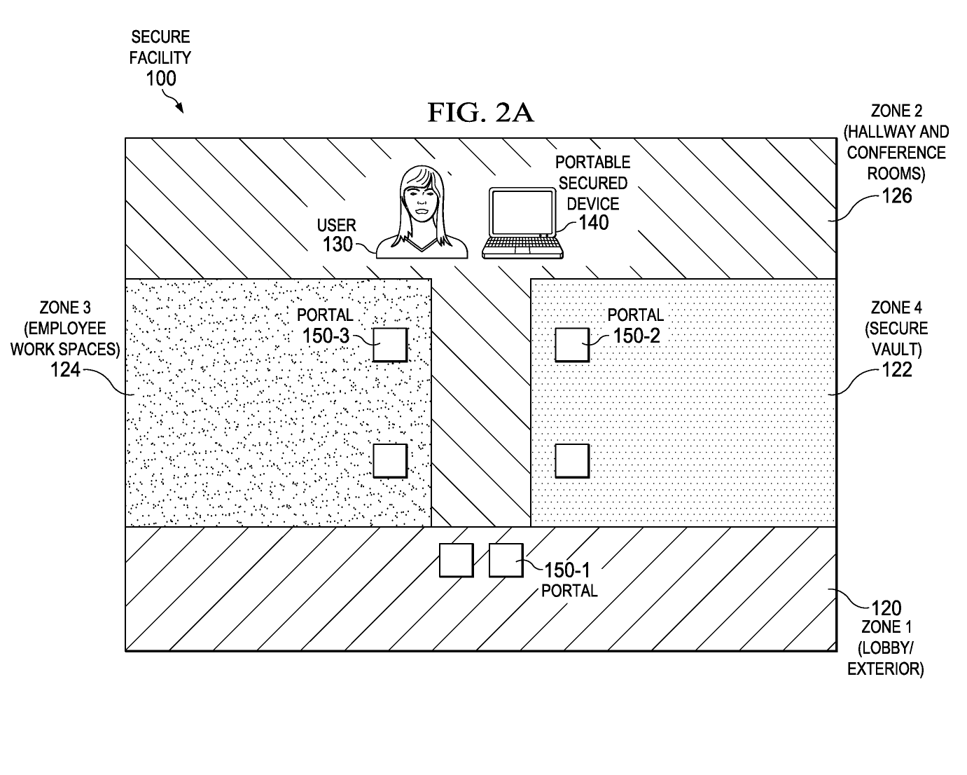

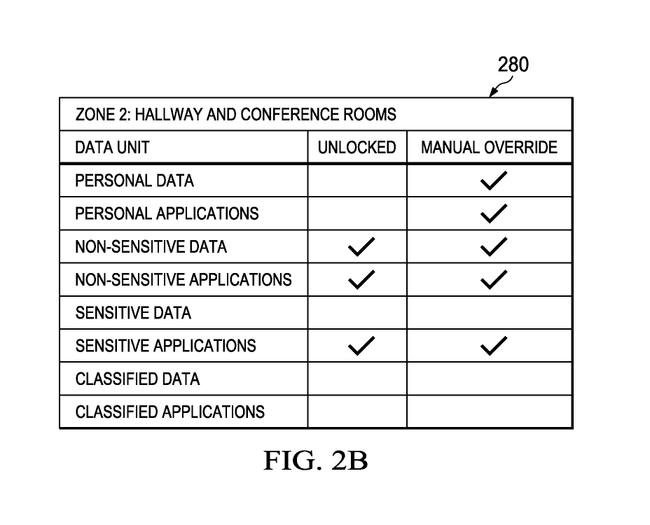

FIGS. 2A and 2B are a plan view of a secure facility 100 and a security policy applicable to zone 2 126 according to one or more examples present Specification. FIGS. 2A and 2B will be considered jointly for purposes of discussion. As with FIGS. 1A and 2A, secure facility 100 includes zone 1 120, zone 2 126, zone 3 124, and zone 4 122.

In FIG. 2A, user 130 has taken portable secured device 140 from zone 1 120 into zone 2 126. As noted above, zone 2 126 is a hallway and conference room area, wherein user 130 performs some business functions, but in which non-enterprise actors may also be found. Security policy 280 may be designed in light of the different circumstances of zone 2 126. Because zone 2 126 is a designated enterprise area, personal data and personal applications are disabled by default. Nonsensitive data, nonsensitive applications, and sensitive applications are enabled by default. This is in recognition of the fact that within zone 2 126, user 130 may be meeting with non-enterprise actors, and may need to review certain nonsensitive data, or use nonsensitive or sensitive applications. However, sensitive data should not be shared with non-enterprise actors. Thus, according to security policy 280, sensitive data are not unlocked by default, and no manual override is available.

Manual overrides are provided for personal data, personal applications, nonsensitive data, nonsensitive applications, and sensitive applications. This means, that in the case of personal data and personal applications, user 130 may manually decrypt these partitions by providing a security token, which will give user 130 access to her personal data if she needs to access that personal data while in zone 2 126. It should be noted, however, that additional firewalls or other barriers may be provided on portable secured device 140 or within the enterprise network to ensure that personal data and personal applications are not intermingled with enterprise data and applications, and are not backed up to enterprise servers. The provision of personal data and personal applications in a separate partition may assist in more effectively providing and enforcing such barriers.

Manual overrides are also provided for nonsensitive data, nonsensitive applications, and sensitive applications. Because these overrides represent encrypting available partitions, they may not have a built-in expiration time as did certain overrides in security policy 180. Thus, for example, if user 130 is meeting with a non-enterprise actor such as a client or vendor within zone 2 126, she may choose to encrypt nonsensitive data and sensitive applications, and rely solely on nonsensitive applications. These manual overrides may remain in place until user 130 manually decrypts the partitions, or until portable secured device 140 moves to a different zone.

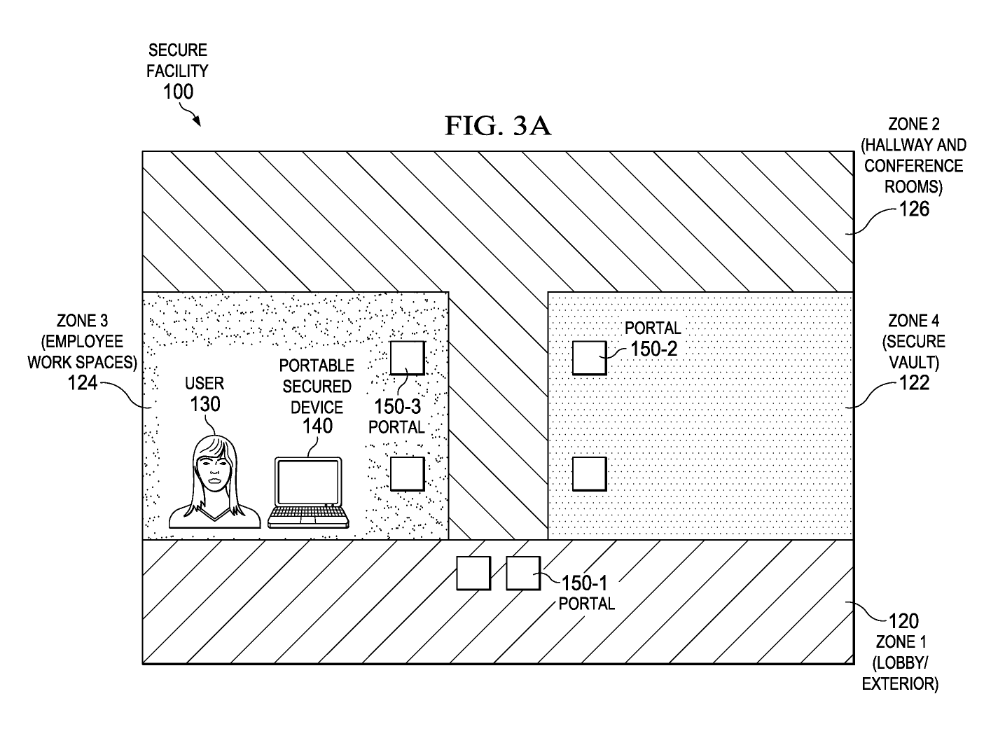

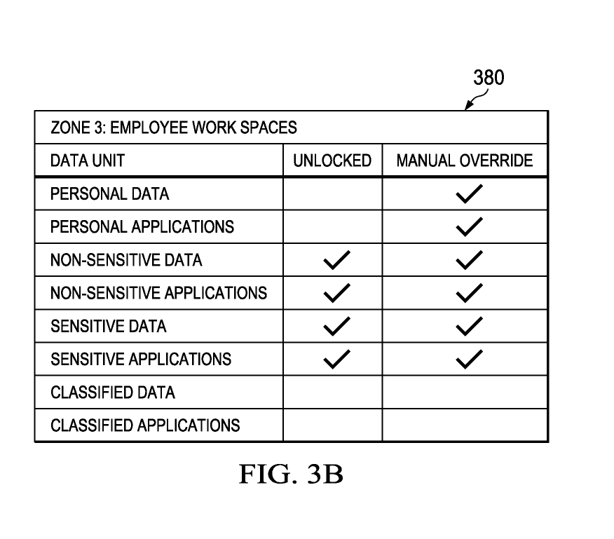

FIGS. 3A and 3B are a plan view of secure facility 100 and an associated security policy 380 according to one or more examples of the present Specification. As with FIGS. 1A and 2A, secure facility 100 includes zone 1 120, zone 2 126, zone 3 124, and zone 4 122.

In this example, user 130 has moved from zone 2 126 into zone 3 124. Because zone 3 124 is an employee workspace, and has higher inherent security features than zone 2 126, security policy 380 applies.

According to security policy 380, nonsensitive data, nonsensitive applications, sensitive data, and sensitive applications are all unlocked by default. Personal data and personal applications are locked by default, but are subject to manual override. Classified data and classified applications are locked, and are not subject to manual override.

Security policy 380 recognizes that in order for user 130 to efficiently and effectively perform her job function, she needs access to enterprise data and enterprise applications. In it also recognizes that in the normal case, user 130 does not need to access her personal data and personal applications while working within employee workspace of zone 3 124. However, the manual override is provided so that if for some reason user 130 does need to access personal data and personal applications during work hours or in a work environment, she may be able to do so. Note also that while the partitions for nonsensitive data, nonsensitive applications, sensitive data, and sensitive applications are decrypted by default, user 130 may choose to manually encrypt these partitions if the need arises.

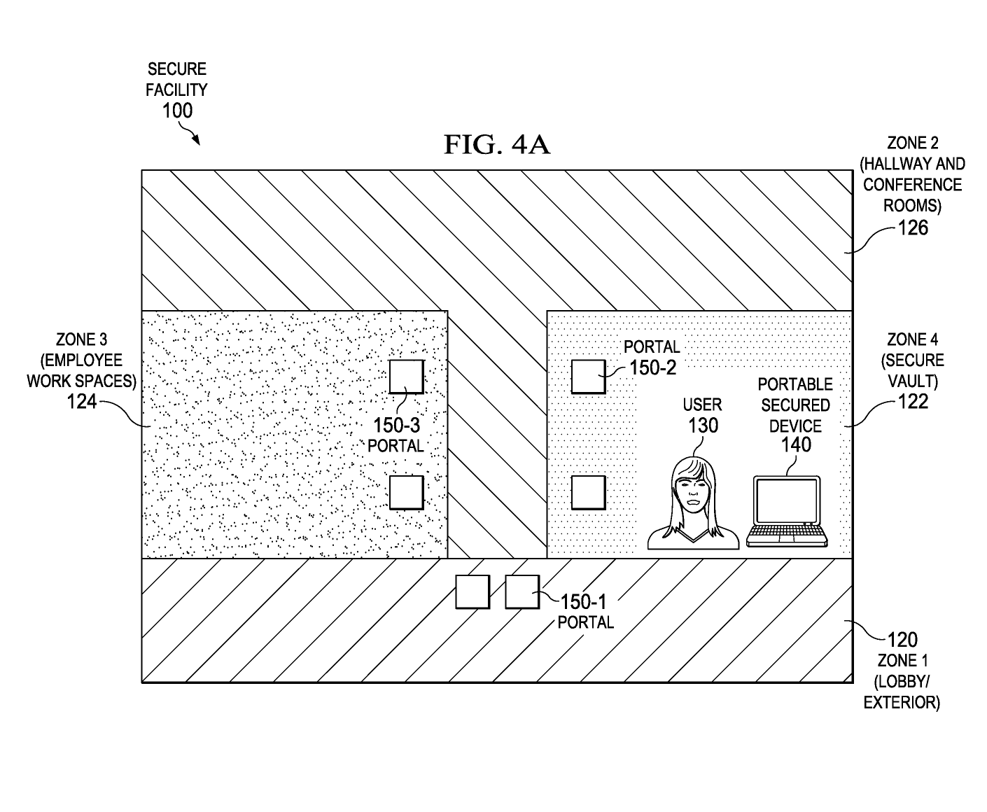

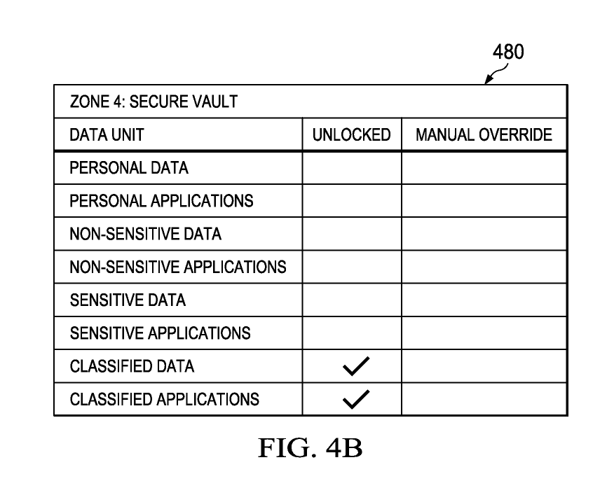

FIGS. 4A and 4B are a plan view of secure facility 100 and an associated security policy 480 according to one or more examples of the present Specification. As with FIGS. 1A and 2A, secure facility 100 includes zone 1 120, zone 2 126, zone 3 124, and zone 4 122.

In FIG. 4A, user 130 has moved from zone 3 124 into the secure vault of zone 4 122. Within zone 4 122, user 130 is required to access classified data and classified applications. Unlike with other zones, the increased security of zone 4 122 does not allow user 130 to inherently have access to lower security data and applications. Rather, the nature of zone 4 122 is that user 130 is required to access classified data and classified applications, and no other data or applications. This ensures that the partitions for classified data and classified applications are not tainted or compromised by lower-security partitions. This also ensures that user 130 cannot store classified data or classified applications on lower security partitions of portable secured device 140. In fact, this configuration may enable user 130 to use portable secured device 140 within zone 4 122, whereas without such a policy, zone 4 122 may be provided only with dedicated computing devices, and user 130 may not be allowed to take any devices into or out of zone 4 122.

In one example, a master copy of classified data and classified applications may be maintained on a computer or server within zone 4 122. When user 130 brings portable secured device 140 into zone 4 122, she may be permitted to work on classified data and classified applications on portable secured device 140. To be able to do this, she may need to apply a secure boot image to one of the classified data or classified applications partitions to boot portable secured device 140. In this configuration, portable secured device 140 is allowed to access only the classified data and classified applications partitions that are created in the secure boot process. Once user 130 takes portable secured device 140 out of zone 4 122, the classified partitions may be securely wiped to ensure that no recoverable copies of those data remain on portable secured device 140. This secure wiping may include, for example, one or more overwrite passes of the partitions with either all zeroes, all ones, or with random data. This ensures that the two partitions are completely wiped and not subject to recovery.

Considering FIGS. 1A-4B jointly now, a mechanism for determining a location of user 130 and portable secured device 140 is disclosed. In one example, at the entrance to each zone, there is a portal 150. Portal 1 150-1 is disposed between zone 1 120 and zone 2 126. Portal 2 150-2 is disposed between zone 2 126 and zone 4 122. Portal 3 150-3 is disposed between zone 2 126 and zone 3 124.

In broad terms, each portal 150 is a form of physical gate or entry barrier that allows user 130 and portable secured device 140 and to pass through while registering the presence of at least one of them. Portable secured device 140 may be provided with a “proximity switch.” In this context, a proximity switch includes any combination of hardware or software that enables portable secured device 140 to communicate with portal 150 to determine that user 130 and portable secured device 140 have entered or exited an area. Examples of short-range wireless communication technologies could include, but are not limited to radio frequency identification (RFID), RuBee IEEE 1902.1 standard (IEEE std. 1902.1, published 2009), etc.

In one example, the proximity trigger of portable secured device 140 is an RFID tag, while portal 150-1 includes one or more RFID readers. Thus, when it is known that portable secured device 140 is in zone 1 120, if portable secured device 140 passes through portal 1 150-1, it is determined that portable secured device 140 is now in zone 2 126. Similarly, when portable secured device 140 passes through portal 2 150-2, it is determined that portable secured device 140 is in zone 4 122. Finally, when portable secured device 140 passes through portal 3 150-3, it is determined that portable secured device 140 is now in zone 3 124.

In reverse order, portable secured device 140 may pass from zone 3 through portal 3 150-3, in which case it is inferred that portable secured device 140 is in zone 2 126. If portable secured device 140 is in zone 4 122 and crosses portal 2 150-2, it is determined secure device 140 is within zone 2 126. If portable secured device 140 is in zone 2 126 passes through portal 1 150-1, it is determined portable secure device 140 is now in zone 1 120.

In one example, a concern that arises is if portable secured device 140 gets near enough to a portal 150 to trigger a transition event, but user 130 does not actually exit the old zone or enter a new zone. For example, if employee 130 is working within zone 3 124, and approaches portal 3 150-3, she may get near enough for the proximity trigger of portable secured device 140 to trigger portal 3 150-3. But then user 130 may remember that she forgot something at her desk, turn around, and go back into his zone 3 124 without ever passing completely into zone 2 126. After user 130 has retrieved thing that she forgot, when she passes through portal 3 150-3 into zone 2 126, portable secured device 140 may determine that she has actually passed into zone 3 124 from zone 2 126. In that case, portable secured device 140 may apply security policy 380 of FIG. 3B instead security policy 280 FIG. 2B. This can result in user 130 having access to sensitive data and applications within zone 2 126, where those partitions should not be available.

Later, when user 130 passes through portal 1 150-1 into zone 1 120, portable secured device 140 may enter an undefined state, because there is no portal from zone 3 124—where portable secured device 140 thinks it currently sits—into zone 1 120.

In that case, as soon as portable secured device 140 enters an undefined state, it may default to security policy 180 of FIG. 1B. This represents a failsafe mode where no sensitive applications or data are available by default.

In another embodiment, this situation may be at least partly alleviated by providing two or more trigger readers within portals 150. For example, where the proximity trigger of portable secured device 140 is an RFID tag, and portals 150 are RFID readers, each portal 150 may include two or more RFID readers spaced apart from one another. By determining the order in which the RFID readers are traversed by the RFID tag of portable secured device 140, it may be determined which direction portable secured device 140 passed through the portal 150. In this case, if user 130 passes through portal 3 150-3 from left to right on plan view 100, it is determined that portable secured device 140 has entered zone 2 126, regardless of which state portable secured device 140 was in before crossing portal 3 150-3. This technique may help to minimize undefined states and erroneous states.

In yet another example, additional granularity of policy control may be provided by adding additional authentication factors. In the context of the preceding FIGURES, security policies have been discussed strictly in terms of the location of portable secured device 140. However, it is possible to also identify which user 130 is logged onto portable secured device 140. Thus, if portable secured device 140 is a multiuser device, portable secured device 140 may further report which user is logged in, and security policies may be adjusted appropriately. For example, some users may be granted access to nonsensitive data, but not access to sensitive data or classified data. This example may include single-factor or multi-factor authentication, such as a username/password combination and a security token such as a key fob, identification badge, or biometric characteristic (e.g., fingerprint, eyes, facial feature, hand features, pulse, etc.) that authenticates user 130 to portable secured device 140. In other embodiments, a portal 150 may be configured to detect a badge, key fob, biometric characteristic, or similar, so that portal 150 may identify user 130 separately from portable secured device 140.

Another factor that may be considered is timing. For example, in FIG. 4A, when user 130 enters zone 4 122, the classified data and classified applications partitions of portable secured device 140 may be decrypted only during certain times of the day. For example, working with classified data and classified applications may be restricted to regular business hours of 8 AM to 5 PM. Thus, if user 130 enters zone 4 122 late at night, classified data and classified applications partitions will both remain encrypted, so that portable secured device 140 will have no useful function during non-authorized times.

In another example, user 130 may be permitted to access the classified data and classified applications partitions any time so long as she is within zone 4 122, and so long as another user is also located within zone 4 122. This policy ensures that user 130 does not work on classified data and classified applications alone.

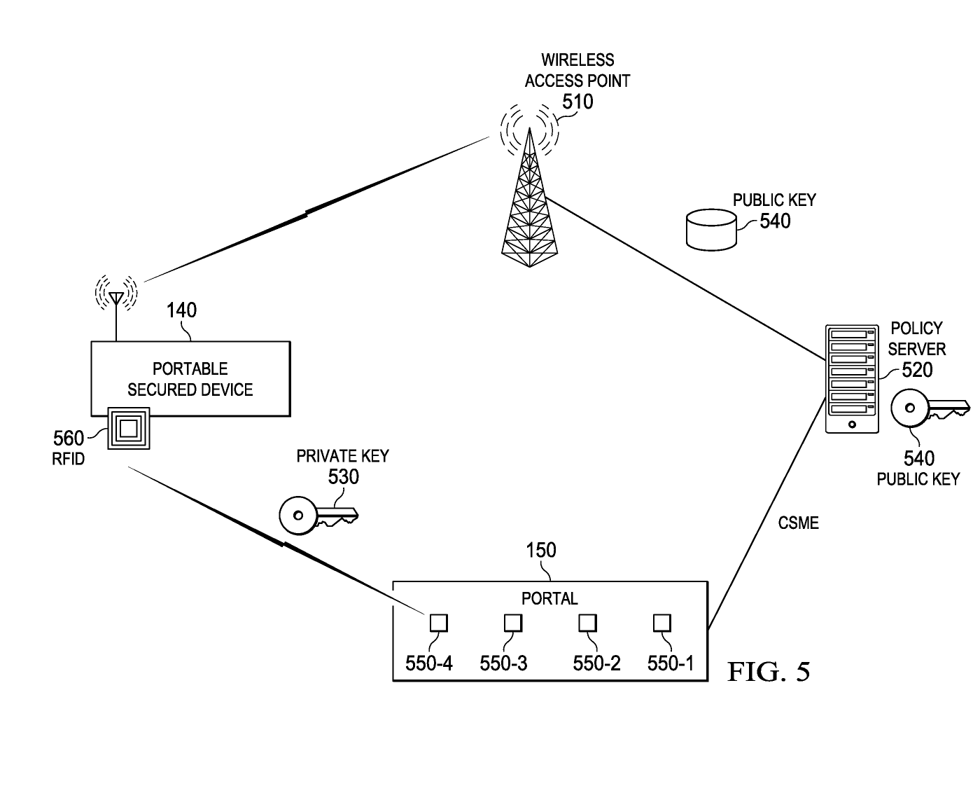

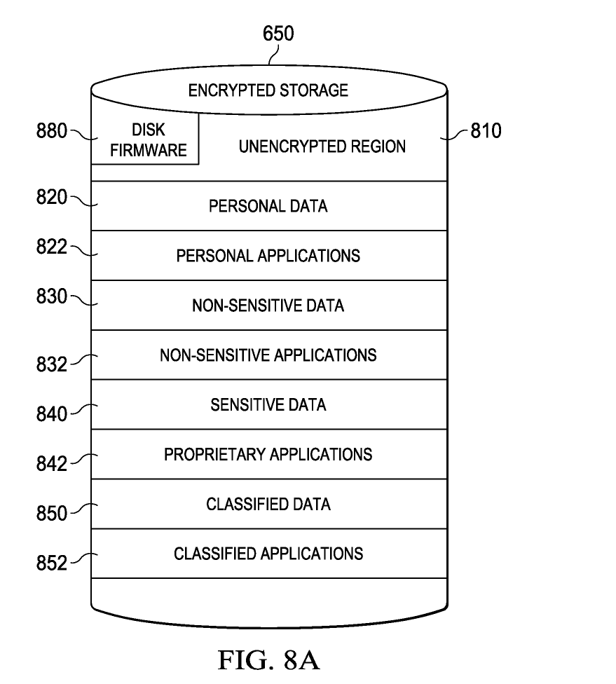

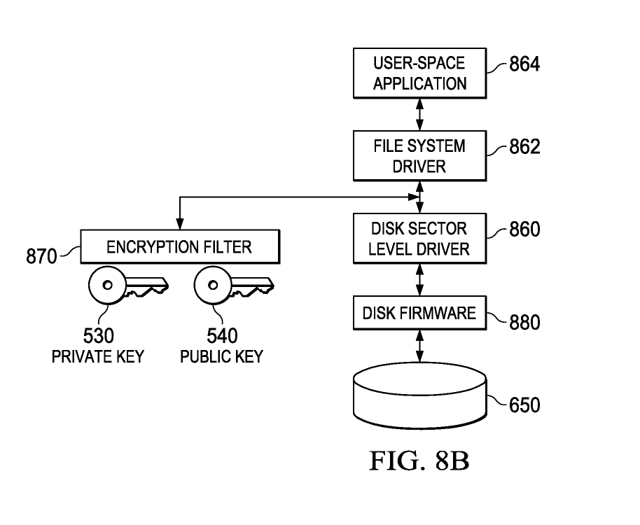

FIG. 5 is a network diagram of policy application according to one or more examples of the present Specification. In FIG. 5, portable secured device 140 includes RFID tag 560. In some cases, a separate RFID tag 560 may be provided for each partition disclosed in FIG. 8. Portable secured device 140 also includes a local copy of a private key 530, which may be used as one part of a two-part decryption scheme for one or more partitions on portable secured device 140. Portal 150 includes four RFID readers, 550-1, 550-2, 550-3, and 550-4. By way of example, it may be assumed that employee workspaces in zone 3 124 are on the left side of portal 150, and the hallways and conference rooms of zone 2 126 are on the right side of portal 150. As described above, RFID tag 560 acts as a proximity trigger. As user 130 approaches portal 150, RFID reader 550-4 triggers first. RFID reader 550-3 trigger second, followed by RFID reader 550-2 and RFID reader 550-1. It is thus inferred that user 130 has passed from zone 3 124 into zone 2 126. Portal 150 may report to policy server 520 that portable secured device 140 has passed into zone 2 126. Portable secured device 140 may then communicate wirelessly to wireless access point 510 or through customized switched metro Ethernet (CSME) via portal 150, which communicatively couple portable secured device 140 to policy server 520. Portable secured device 140 may request a security token for zone 2 by transmitting a token request to policy server 520. In other examples, portable secured device 140 may communicate via a kernel-level service at the driver level.

Policy server 520 receives the token request and generates a public key 540 that contains the second half of the decryption key along with private key 530. Policy server 520 then securely wirelessly transmits a data packet including public-key 540, via wireless access point 510 or via CSME through portal 150 to portable secured device 140. Portable secured device 140 now includes all information necessary to decrypt partitions authorized for use in zone 2 126.

In another example, public key 540 may be transmitted to RFID 560 via Intel® wireless credential exchange (WCE) or a similar or equivalent technology. WCE provides an RFID 560 with substantially larger storage space than traditional RFIDs. Storing keys within RFID 560 provides a tamper-resistant medium for containing the keys. In an example, communication between portal 150 and policy server 520 may be via CSME or a similar protocol. In this case, RFID 560 acts as a species of network interface for portable secured device 140, in addition to other network interfaces that may be provided, such as WiFi and Ethernet interfaces.

Notably, this distributed authentication scheme helps to ensure that portable secured device 140 cannot be easily compromised. Even if a user manages to hack portable secured device 140, because encrypted partitions remain encrypted without public key 540, the hacker's useful work on portable secured device 140 is extremely limited. This may be true even in cases where the security policy allows for certain overrides. Those overrides may be such that they are possible only when an appropriate security key is received from policy server 520 in addition to the key manually provided by user 130. Thus, an attempt to use the override in an improper context will fail to decrypt the secure partition.

Further advantageously, the use of an RFID tag 560 or other similar passive proximity trigger device enables reporting of the location of portable secured device 140 even when portable secured device 140 is turned off. Thus, a user cannot defeat the security scheme by simply turning off portable secured device 140 while in a secured area, and then moving to an unsecured area and rebooting the computer.

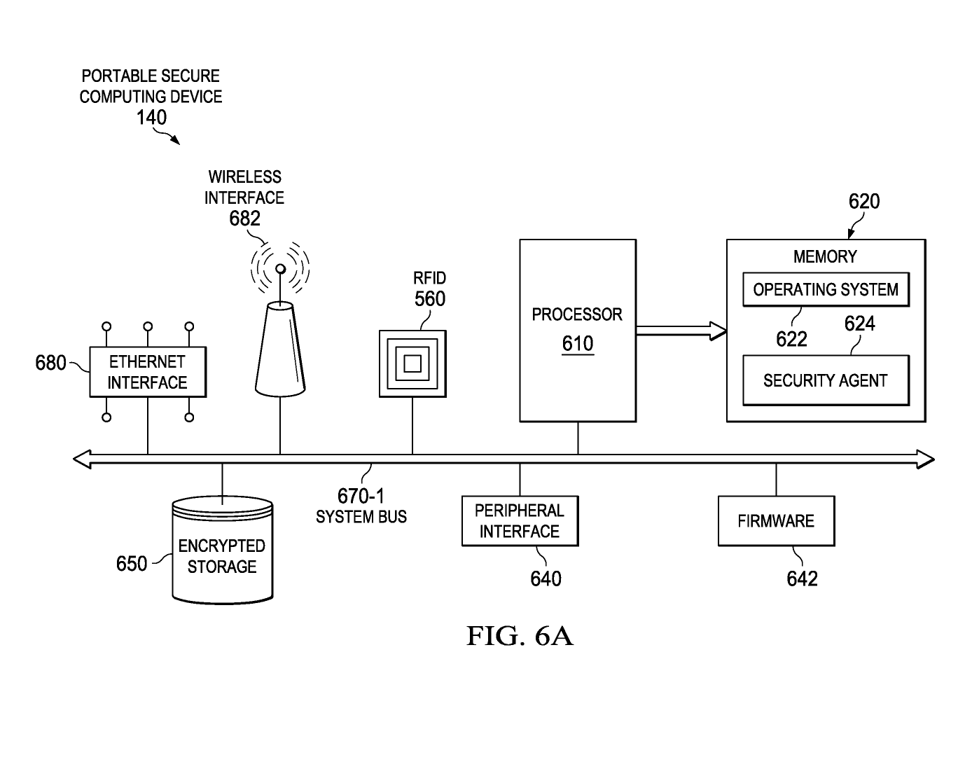

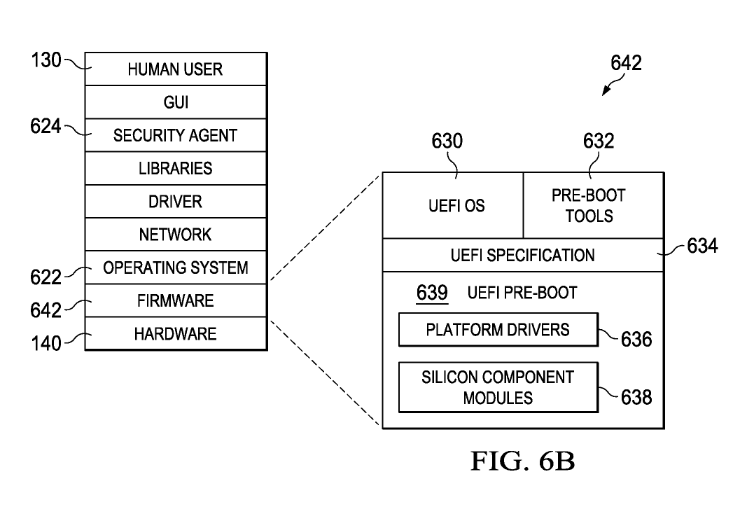

FIG. 6A is a block diagram of portable secured device 140, which is a species of computing device, according to one or more examples of the present Specification. In various embodiments, a “computing device” may be or comprise, by way of non-limiting example, a computer, embedded computer, embedded controller, embedded sensor, personal digital assistant (PDA), laptop computer, cellular telephone, IP telephone, smart phone, tablet computer, convertible tablet computer, handheld calculator, or any other electronic, microelectronic, or microelectromechanical device for processing and communicating data.

Portable secured device 140 includes a processor 610 connected to a memory 620, having stored therein executable instructions for providing an operating system 622 and security agent 624. Other components of portable secured device 140 include a firmware 642, peripheral interface 640, encrypted storage 650, Ethernet interface 680, wireless interface 682, and RFID 560.

As used throughout this Specification, a “processor” includes any combination of hardware, software, or firmware providing programmable logic, including by way of non-limiting example a microprocessor, digital signal processor, field-programmable gate array, programmable logic array, application-specific integrated circuit, or virtual machine processor. In an example, processor 610 is communicatively coupled to memory 620 via memory bus 670-1, which may be for example a direct memory access (DMA) bus. Processor 610 may be communicatively coupled to other devices via a system bus 670-1. As used throughout this Specification, a “bus” includes any wired or wireless interconnection line, network, connection, bundle, single bus, multiple buses, crossbar network, single-stage network, multistage network or other conduction medium operable to carry data, signals, or power between parts of a computing device, or between computing devices. It should be noted that these uses are disclosed by way of non-limiting example only, and that some embodiments may omit one or more of the foregoing buses, while others may employ additional or different buses.

Processor 610 may be connected to memory 620 in a DMA configuration via memory bus 670-3. To simplify this disclosure, memory 620 is disclosed as a single logical block, but in a physical embodiment may include one or more blocks of any suitable volatile or non-volatile memory technology or technologies, including for example DDR RAM, SRAM, DRAM, cache, L1 or L2 memory, on-chip memory, registers, flash, ROM, optical media, virtual memory regions, magnetic or tape memory, or similar. In certain embodiments, memory 620 may comprise a relatively low-latency volatile main memory, while encrypted storage 650 may comprise a relatively higher-latency non-volatile memory. However, memory 620 and encrypted storage 650 need not be physically separate devices, and in some examples may represent simply a logical separation of function. It should also be noted that although DMA is disclosed by way of non-limiting example, DMA is not the only protocol consistent with this Specification, and that other memory architectures are available.

Encrypted storage 650 may be any species of memory 620, or may be a separate device, such as a hard drive, solid-state drive, external storage, redundant array of independent disks (RAID), network-attached storage, optical storage, tape drive, backup system, cloud storage, or any combination of the foregoing. Encrypted storage 650 may be, or may include therein, a database or databases or data stored in other configurations, and may include a stored copy of operational software such as an operating system and a stored copy of operating system 622 and security agent 624. In some cases, encrypted storage 650 may be provided with inline encryption capabilities. Many other configurations are also possible, and are intended to be encompassed within the broad scope of this Specification.

Peripheral interface 640 is provided for communicatively coupling to zero or more peripherals. Peripherals include any auxiliary device that connects to portable secured device 140 but that is not necessarily a part of the core architecture of portable secured device 140. A peripheral may be operable to provide extended functionality to portable secured device 140, and may or may not be wholly dependent on portable secured device 140. In some cases, a peripheral may be a computing device in its own right. Peripherals may include input and output devices such as displays, terminals, printers, keyboards, mice, modems, network controllers, sensors, transducers, actuators, controllers, data acquisition buses, cameras, microphones, speakers, or external storage by way of non-limiting example.

Operating system 622 includes any one or more software components operable for providing low-level hardware access, resource management, shared services, and/or an abstraction layer for user-space programs. Operating systems may be provided with a kernel, such as a monolithic kernel or microkernel.

Firmware 642 may be a species of persistent memory including both instructions and data, or an equivalent device. In one example, a unified extensible firmware interface (UEFI)-compliant firmware, which provides a secure platform for endpoint pre-boot authentication (PBA) and secure booting. Thus, security agent 624 may be partly encoded within firmware 642.

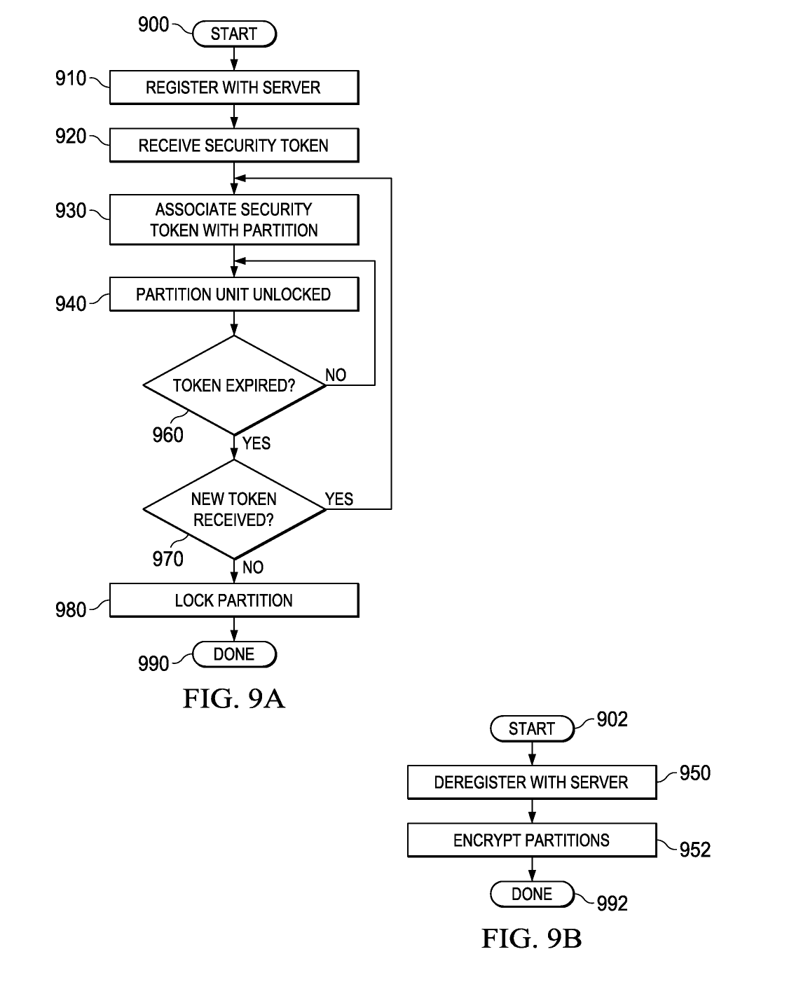

Security agent 624, in one example, is a utility or program that carries out a method or part of a method 900 of FIG. 9, or other methods according to this Specification, and may operate as a “daemon” process. A “daemon” may include any program or series of executable instructions, whether implemented in hardware, software, firmware, or any combination thereof, that runs as a background process, a terminate-and-stay-resident program, a service, system extension, control panel, bootup procedure, BIOS subroutine, or any similar program that operates without direct user interaction. It should also be noted that security agent 624 is provided by way of non-limiting example only, and that other software, including interactive or user-mode software, may also be provided in conjunction with, in addition to, or instead of security agent 624 to perform methods according to this Specification.

In one example, security agent 624 includes executable instructions stored on one or more non-transitory computer-readable mediums operable to perform methods 900 and 902 of FIGS. 9A and 9B, or a similar method according to this Specification. At an appropriate time, such as upon booting portable secured device 140 or upon a command from operating system 622 or user 130, processor 610 may retrieve a copy of security agent 624 from encrypted storage 650 and load it into memory 620. Processor 610 may then iteratively execute the instructions of security agent 624.

Security agent 624 may be configured to work cooperatively with encrypted storage 650, firmware 642, RFID 686, and wireless interface 682. For example, upon passing a portal 150 of FIG. 1A, RFID 686 identifies itself to one or more RFID readers by 50 of portal 150. In one example, RFID tag 560 has limited intelligence capabilities. For example, RFID tag 560 may only be able to provide a unique identifier to RFID reader 550. RFID reader 550 may then communicate with policy server 520 to indicate that portable secured device 140 has passed into zone 2. Portable secured device 140 may also receive a signal from RFID tag 560 indicating that portable secured device 140 has passed into zone 2. Portable secured device 140 may then register with policy server 520, and request a public key 540 appropriate for an zone 2 126.

In registering with policy server 520 and requesting public key 540, portable secured device 140 may provide additional data to policy server 520. For example, portable secured device 140 may indicate which user is logged on, a timestamp of the request, whether any manual overrides have been applied, what peripherals are attached, and other relevant data. Policy server 520 may then craft a public key 540 that is specifically applicable to those factors. Thus, highly granular control over disk encryption may be provided based on a plurality of factors.

FIG. 6B provides additional details of portable secured device 140 according to one or more examples of the present Specification. FIG. 6B depicts a system architecture in a “stack” representation. In this architecture, user 130 interacts with a user interface such as a graphical user interface (GUI), provided for example via peripherals attached to peripheral drivers 660. The GUI connects user 130 to security agent 624. Underneath security agent 624 are libraries, drivers, and a network respectively. These are hosted on operating system 622, which overlays firmware 642, which overlays physical hardware of portable secured device 140.

Firmware 642 is broken out in greater detail. In this example, firmware 642 includes an embedded UEFI operating system 630, and pre-boot tools 632 which run on UEFI OS 630. A UEFI Specification 634 underlays both of these, and provides connectivity to a UEFI pre-boot sector 639. UEFI pre-boot sector 639 includes, by way of example, platform drivers 636 and silicon component modules 638.

UEFI OS 630 and pre-boot tools 632 may include, in certain embodiments, all or part of security agent 624.

Security agent 624 may provide low-level encryption and decryption services that are transparent to higher-level applications. This feature is discussed in more detail in connection with FIG. 8B. In certain embodiments, security agent 624 may run on a tamper resistant isolated execution environment independent of host processing, or in a secured area of memory such as an “enclave,” such as those provided by Intel® Software Guard Extensions (SGX) instructions.

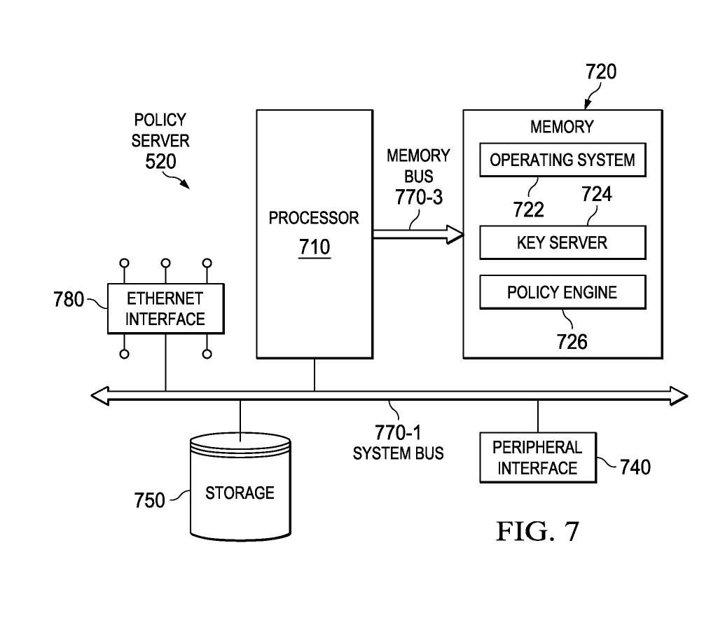

FIG. 7 is a block diagram of policy server 520 according to one or more examples of the present Specification. Policy server 520 includes a processor 710 connected to a memory 720, having stored therein executable instructions for providing an operating system 722, key server 724, and policy engine 726.

In an example, processor 710 is communicatively coupled to memory 720 via memory bus 770-3, which may be for example a DMA bus. Processor 710 may be communicatively coupled to other devices via a system bus 770-1, including an Ethernet interface 780, storage 750, and peripheral interface 740. Each of the definitions and examples provided in connection with FIG. 6A are also applicable to corresponding devices and structures in FIG. 7.

Processor 710 may be connected to memory 720 in a DMA configuration via DMA bus 770-3. To simplify this disclosure, memory 720 is disclosed as a single logical block, but in a physical embodiment may include one or more blocks of any suitable volatile or non-volatile memory technology or technologies.

Storage 750 may be any species of memory 720, or may be a separate device. Storage 750 may include a stored copy of operational software such as operating system 722, key server 724, and policy engine 726. Many other configurations are also possible, and are intended to be encompassed within the broad scope of this Specification.

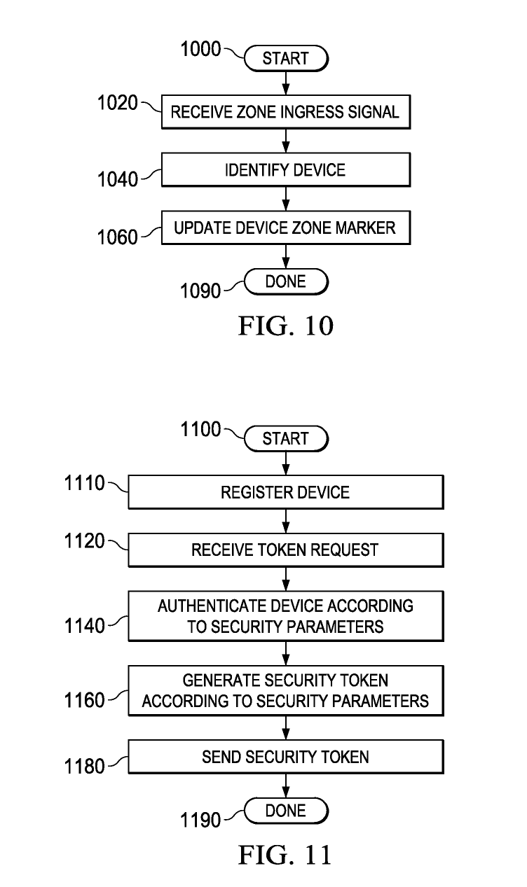

Key server 724 and policy engine 726 may be, in an example, utilities or program that together carry out methods, such as those disclosed in FIGS. 10 and 11. It should be noted that key server 724 and policy engine 726 are provided by way of non-limiting example only, and that other software, including interactive or user-mode software, may also be provided in conjunction with, in addition to, or instead of key server 724 and policy engine 726 to perform methods according to this Specification.

In one example, key server 724 and policy engine 726 include executable instructions stored on one or more non-transitory computer-readable mediums operable to perform methods 1000 and 1100 of FIGS. 10 and 11 respectively, or similar methods according to this Specification. At an appropriate time, such as upon booting policy server 520 or upon a command from the operating system or a user, processor 710 may retrieve a copy of key server 724 and/or policy engine 726 from storage 750 and load it into memory 720. Processor 710 may then iteratively execute the instructions of key server 724 and/or policy engine 726.

Key server 724 may be particularly operable to generate certain disk encryption keys (DEKs), such as public key 540 of FIG. 5, which will enable secure portable device 140 to unlock particular partitions of storage 750.

FIGS. 8A and 8B are block diagrams of encrypted storage 650 according to one or more examples of the present Specification. As seen in FIG. 8A, encrypted storage may be divided into a plurality of partitions. An unencrypted region 810 may be provided, which may be a generally accessible region requiring no specific decryption key. Note that the use of an unencrypted region 810 may need to be supplemented with specific drivers to block out disk operations on unencrypted region 810, for example in zone 4 122, and where unsecured disk operations are not permitted. In other use cases, unencrypted region 810 may be continuously available, or no unencrypted region 810 may be provided. Additional regions are provided for personal data 820, personal applications 822, nonsensitive data 830, nonsensitive applications 832, sensitive data 840, proprietary applications 842, classified data 850, and classified applications 852. These may conform substantially to the earlier disclosures in this Specification. In some cases, each separate partition may need to be aligned with disk sector boundaries. This enables encrypted storage 650 to use sector-level drivers to control access, encryption, and decryption of separate partitions during relevant operations. In other embodiments, drivers may be provided that enable a more granular level of control, such as at the file level. In this case, individual files may be designated as belonging to six specific partitions, and those files may be decrypted and made available only in appropriate zones. In yet other examples, each partition disclosed herein may be a separately defined “drive letter” (in Microsoft Windows operating systems), “mount point” (in Unix-like operating systems) or similar. The use of separate drive letters or mount points may help to further segregate data, because the driver may have the capability to allow or prevent copying of data between certain drive letters or mount points. It should be noted that these partitioning methods are disclosed by way of example only, and many other schemes for partitioning encrypted storage 650 may be available. It is intended that the Specification broadly apply to all such partitioning schemes.

In an embodiment, a special disk firmware 880 is provided for additional security. Disk firmware 880 may provide some or all of the functions described with respect to firmware 642 of FIG. 6A, including some or all of security agent 624. Advantageously, disk firmware 880 may be physically resident with an encrypted storage 650. This means that the policy enforcement provisions of the present Specification cannot be defeated, for example, by physically removing encrypted storage 650 from portable secured device 140. Such an operation may enable a malicious attacker to have an unbounded time. In which to work on encrypted storage 650 and attempt to decrypt regions of interest. By embedding disk firmware 880 with an encrypted storage 650, it is ensured that if an encrypted storage 650 is moved to a new device, once it is powered up, it can take appropriate countermeasures, such as securely wiping its sectors, or even activating a failsafe that physically damages platters or memory elements, so that the attacker cannot easily remove those platters in an attempt to scan them outside of the disk drive.

FIG. 8B is an operational stack view of encrypted storage 650 according to one or more examples of the present Specification. Viewing the operational stack from the “bottom up,” elements are disclosed (starting at encrypted storage 650) in order of decreasing privilege level and increasing logic level. Thus, encrypted storage 650, disk firmware 880, and disk sector level driver 860 may be considered to operate at a logically lower level, or conversely at a higher or more escalated privilege level, than file system driver 862 and user-space applications 864.

Encrypted storage 650 is operated in this example by disk firmware 880. Disk firmware 880 interfaces to disk sector level driver 860. This is provided for cases where sector level partitioning is enabled, such that each partition falls on a sector boundary, and sector level driver 860 separately encrypts or decrypts sectors. Sector level driver 860 communicatively couples to encryption filter 870. Encryption filter 870 is configured to receive private key 530 and public key 540 and provide sector level encryption and decryption.

File system driver 862 communicatively couples to disk sector level driver 860. File system driver 862 need not be aware of encryption or decryption taking place at sector level driver 860. Rather, sector level driver 860 reports to file system driver 862 only those sectors that are currently unencrypted and available. Thus, in a case where each partition is provided as a separate drive letter, only drive letters that are currently unencrypted and available will be mounted to the disk. In other cases, only files, folder, or directories that are unencrypted and available are shown.

Thus, as far as file system driver 862 is concerned, encrypted and unavailable sectors do not exist. Finally, user space applications 864 communicatively couples to file system driver 862. Like file system driver 862, user space applications need not and may not be aware of encryption and decryption taking place at disk sector level driver 860. In certain embodiments, this restriction of encryption and decryption to user space application 864 ensures that user space applications 864 may not tamper with the encryption filter 870.

FIGS. 9A and 9B are flow chart views of methods 900 and 902 performed by a security agent 624 according to one or more examples of the present Specification.

In method 900, starting in block 910, portable secured device 140 registers with policy server 520 according to methods described herein. During the registration process, portable secured device 140 requests public key 540 from policy server 520.

In block 920, portable secured device 140 receives public key 540 from policy server 520. This may be provided either over wireless access point 510, or to RFID 560 via WCE for example.

In block 930, portable secured device 140 associates public key 540 with a partition. In some cases, security agent 624 need not be aware of which zone portable secured device 140 is in. Rather, security agent 624 may be configured to passively accept a security token, and merely associated security token with an appropriate partition. In other cases, security agent 624 may be aware of which zone that it's in, for example by receiving a report from RFID 560. In that case, security agent 624 may request keys for certain partitions of encrypted storage 650, so that a greater portion of the intelligence resides within security agent 624. It will be noted that other distributions of intelligence are also compatible with this method.

In block 940, security agent 624 uses public key 540 to decrypt a partition as described herein. Thus, the partition is unlocked.

In block 960, there is a check to see whether the token has expired. This loop represents a timeout feature, wherein a token may be valid for only a short time, so that portable secured device 140 cannot easily be spoofed if it is somehow removed from its present zone without triggering portal 150. If the token is not expired, then the method loops back to partition 940, and waits until the token is expired.

In block 970, portable secured device 140 may attempt to receive a new token from policy server 520. If the new token is received, then control returns to block 930, and the partition remains unlocked until the token expires.

If a new token is not received in block 970, then in block 980 security agent 624 may perform a security action such as, for example, locking the partition. This may include re-encrypting the partition and locking out access through sector level driver 860.

In block 990, the method is done.

FIG. 9B provides a method 902, used when portable secured device 140 leaves a particular zone. In this case, in block 950, security agent 624 deregisters with policy server 520. In block 952, security agent 624 may encrypt relevant partitions. In some cases, leaving a zone causes all or most partitions of encrypted storage 650 to be encrypted and made unavailable. For example, only unencrypted region 810, if it exists, may remain accessible after deregistration with policy server 520 in block 950. This may remain the case until portable secured device 140 registers with policy server 520 in a new zone.

In block 992, the method is done.

FIG. 10 is a block diagram of a method 1000 performed by a policy server 520 according to one or more examples of the present Specification. In block 1020, policy server 520 receives a zone ingress signal from portable secured device 140. This may arrive, for example, via portal 150.

In block 1040, policy server 520 identifies portable secured device 140. Block 1040 may also include, for example, identifying user 130, identifying a timestamp, or identifying any other relevant security factors that may affect the provision of security keys.

In block 1060, policy engine 726 of policy server 520 may update a device zone marker that is associated with portable secured device 140. This allows policy server 520 to keep track of where portable secured device 140 is.

In block 1090, method 1000 is done. It should be noted that method 1000 need not necessarily provide any security keys or other decryption to portable secured device 140. Method 1000 is rather concerned with policy engine 726 ensuring that it keeps a current table of where devices are currently located.

FIG. 11 is a flow chart of a method 1100 that may be performed by a key server 724 of portable secured device 520. It should be noted that key server 724 and policy engine 726 may be provided in a single program, and in some cases, the methods of FIG. 10 in FIG. 11 may provide a single method. Thus, methods 1000 and 1100 are divided herein only for purposes of illustration and to more effectively discuss the different tasks that are performed.

In block 1110, key server 724 registers portable secured device 140, which may include performing some or all of method 1000 or FIG. 10.

In block 1120, key server 724 receives a token request from portable secured device 140.

In block 1140, key server 724 may authenticate portable secured device 140 according to one or more security parameters, as described within this Specification.

In block 1160, key server 724 may generate one or more security tokens according to the currently operative security parameters, for example based on the location of portable secured device 140, the authentication of user 130, the time of day, or other factors as described in this Specification.

In block 1180, if portable secured device 140 is properly authenticated, then key server 724 sends a security token according to methods disclosed herein.

In block 1190, the method is done.

Advantageously, the present Specification provides a computing platform that need not operate in an “all-or-nothing” fashion. The device, along with any allowable data, is available and functional even outside of restricted zones. Further, the device and method of this Specification may provide communication between a chipset OOB IP block to infrastructure RFID, thus avoiding poisoning the host software. Another advantage is that an inline cryptographic interface may be provided, in which a SoC may have the same RFID-qualified re-keying as provided in this Specification, thus removing host software from any interaction with inline encryption.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

The particular embodiments of the present disclosure may readily include a system on chip (SOC) central processing unit (CPU) package. An SOC represents an integrated circuit (IC) that integrates components of a computer or other electronic system into a single chip. It may contain digital, analog, mixed-signal, and radio frequency functions: all of which may be provided on a single chip substrate. Other embodiments may include a multi-chip-module (MCM), with a plurality of chips located within a single electronic package and configured to interact closely with each other through the electronic package. In various other embodiments, the digital signal processing functionalities may be implemented in one or more silicon cores in Application Specific Integrated Circuits (ASICs), Field Programmable Gate Arrays (FPGAs), and other semiconductor chips. In other examples, a solid-state drive (SSD) controller may be provided to implement one or more of the devices described herein.

In example implementations, at least some portions of the processing activities outlined herein may also be implemented in software. In some embodiments, one or more of these features may be implemented in hardware provided external to the elements of the disclosed FIGURES, or consolidated in any appropriate manner to achieve the intended functionality. The various components may include software (or reciprocating software) that can coordinate in order to achieve the operations as outlined herein. In still other embodiments, these elements may include any suitable algorithms, hardware, software, components, modules, interfaces, or objects that facilitate the operations thereof.

Additionally, some of the components associated with described microprocessors may be removed, or otherwise consolidated. In a general sense, the arrangements depicted in the FIGURES may be more logical in their representations, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, equipment options, etc.

Any suitably-configured processor component can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof. In operation, processors may store information in any suitable type of non-transitory storage medium (for example, random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. Further, the information being tracked, sent, received, or stored in a processor could be provided in any database, register, table, cache, queue, control list, or storage structure, based on particular needs and implementations, all of which could be referenced in any suitable timeframe. Any of the memory items discussed herein should be construed as being encompassed within the broad term ‘memory.’ Similarly, any of the potential processing elements, modules, and machines described herein should be construed as being encompassed within the broad term ‘microprocessor’ or ‘processor.’ Furthermore, in various embodiments, the processors, memories, network cards, buses, storage devices, related peripherals, and other hardware elements described herein may be realized by a processor, memory, and other related devices configured by software or firmware to emulate or virtualize the functions of those hardware elements.

Computer program logic implementing all or part of the functionality described herein is embodied in various forms, including, but in no way limited to, a source code form, a computer executable form, and various intermediate forms (for example, forms generated by an assembler, compiler, linker, or locator). In an example, source code includes a series of computer program instructions implemented in various programming languages, such as an object code, an assembly language, or a high-level language such as OpenCL, Fortran, C, C++, JAVA, or HTML for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

In the discussions of the embodiments above, the capacitors, buffers, graphics elements, interconnect boards, clocks, DDRs, camera sensors, dividers, inductors, resistors, amplifiers, switches, digital core, transistors, and/or other components can readily be replaced, substituted, or otherwise modified in order to accommodate particular circuitry needs. Moreover, it should be noted that the use of complementary electronic devices, hardware, non-transitory software, etc. offer an equally viable option for implementing the teachings of the present disclosure.

In one embodiment, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In another embodiment, the electrical circuits of the FIGURES may be implemented as stand-alone modules (e.g., a device with associated components and circuitry configured to perform a specific application or function) or implemented as plug-in modules into application specific hardware of electronic devices.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this Specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended Claims. In order to assist the United States Patent and Trademark Office (USPTO) and, additionally, any readers of any patent issued on this application in interpreting the Claims appended hereto, Applicant wishes to note that the Applicant: (a) does not intend any of the appended Claims to invoke paragraph six (6) of 35 U.S.C. section 112 as it exists on the date of the filing hereof unless the words “means for” or “steps for” are specifically used in the particular Claims; and (b) does not intend, by any statement in the Specification, to limit this disclosure in any way that is not otherwise reflected in the appended Claims.

### Example Implementations

There is disclosed in an example 1, an apparatus comprising:
a storage having at least one secure partition;
a network interface; and
logic, at least partly implemented in hardware for carrying out a method comprising:
   receiving over the network interface a security token that corresponds to a location of the apparatus; and
   applying the security token to the secure partition to provide access to the secure partition based at least in part on the location of the apparatus.

There is disclosed in an example 2, the apparatus of example 1, further comprising a proximity trigger operable to identify the apparatus for establishing the apparatus's location upon crossing a security portal.

There is disclosed in example 3, the apparatus of example 2, wherein the proximity trigger is further operable to determine the apparatus's location upon crossing the security portal

There is disclosed in an example 4, the apparatus of example 2, wherein the proximity trigger is a short-range wireless communication device.

There is disclosed in an example 5, the apparatus of example 2, wherein the proximity trigger is a radio frequency identification (RFID) device.

There is disclosed in an example 6, the apparatus of example 2, wherein the proximity trigger is further configured to provide at least some functions of the network interface.

There is disclosed in an example 7, the apparatus of example 1, wherein the storage has a plurality of secure partitions, and wherein the logic further comprises a data structure for correlating the plurality of secure partitions to a plurality of locations.

There is disclosed in an example 8, the apparatus of example 6, further comprising a sector-level security driver operable to provide access to the secure partitions at a higher privilege level than a file system driver.

There is disclosed in example 9, the apparatus of example 1, further comprising a security driver at least partly embedded in firmware operable to provide access to the secure partition

There is disclosed in an example 10, the apparatus of any of examples 1, wherein the secure partitions are encrypted.

There is disclosed in an example 11, the apparatus of example 10, wherein the security token comprises a decryption key.

There is disclosed in an example 12, the apparatus of example 10, wherein the security token comprises a shared key.

There is disclosed in an example 13, the apparatus of example 1, wherein the network interface is a wireless network interface operable for operation on an encrypted wireless channel.

There is disclosed in an example 14, the apparatus of example 1, further comprising a firmware operable to perform a security action on the secure partition if the security token expires without being renewed.

There is disclosed in an example 15, the apparatus of example 12, wherein the firmware is embedded in the storage.

There is disclosed in an example 16, one or more computer-readable mediums having stored thereon software instructions operable to instruct a processor for:
receiving a security token that corresponds to a location of a storage device; and
applying the security token to a secure partition of the storage to provide access to the secure partition.

There is disclosed in an example 17, the one or more mediums of example 16, further comprising a data structure for correlating access to a plurality of secure partitions to a plurality of locations.

There is disclosed in an example 18, the one or more mediums of example 16 or 17, wherein providing access to the secure partitions comprises decrypting the secure partitions.

There is disclosed in an example 19, the one or more mediums of example 16, wherein the security token comprises a decryption key

There is disclosed in an example 20, the one or more mediums of example 16, wherein the security token comprises a shared key.

There is disclosed in an example 21, the one or more mediums of example 16, wherein the network interface is a wireless network interface operable for operation on an encrypted wireless channel.

There is disclosed in an example 22, the one or more mediums of example 16, wherein the logic is further operable for performing a security action on the secure partition if the security token expires without being renewed.

There is disclosed in an example 23, the one or more mediums of example 22, wherein the logic for performing a security action on the secure partition is resident on the storage.

There is disclosed in an example 24, the one or more mediums of example 16, wherein the logic is further operable for registering upon an apparatus entering a location.

There is disclosed in an example 25, the one or more mediums of example 16, wherein receiving the security token is operable to occur over an radio frequency identification (RFID) device.

There is disclosed in an example 26, a method comprising:
entering a location;
requesting a location-specific security token for accessing a secure partition of a storage device;
receiving the security token; and
granting access to the secure partition.

There is disclosed in example 27, the method of example 26, wherein granting access to the secure partition comprises decrypting the secure partition.

There is disclosed in example 28, an apparatus comprising means for performing the methods of example 26 or 27.

There is disclosed in example 29, the apparatus of example 28, wherein the means comprise a processor and memory.

There is disclosed in example 30, a secure encryption server comprising:
a network interface; and
logic, at least partly implemented in hardware, operable to:
   receive a token request from a device on the network interface;
   authenticate a the device;
   generate a security token for the device; and
   send the security token over the network interface.

What is claimed is:

1. An apparatus comprising:
a storage having at least one secure partition;
a network interface; and
logic, at least partly implemented in hardware for carrying out a method comprising:
receiving over the network interface a security token that corresponds to a location of the apparatus; and
applying the security token to the secure partition to provide access to the secure partition based at least in part on the location of the apparatus.

2. The apparatus of claim 1, further comprising a proximity trigger operable to identify the apparatus upon crossing a security portal.

3. The apparatus of claim 2, wherein the proximity trigger is further operable to determine the apparatus's location upon crossing the security portal.

4. The apparatus of claim 2, wherein the proximity trigger is a short-range wireless communication device.

5. The apparatus of claim 2, wherein the proximity trigger is a radio frequency identification (RFID) device.

6. The apparatus of claim 2, wherein the proximity trigger is further configured to provide at least some functions of the network interface.

7. The apparatus of claim 1, wherein the storage has a plurality of secure partitions, and wherein the logic further comprises a data structure for correlating the plurality of secure partitions to a plurality of locations.

8. The apparatus of claim 6, further comprising a sector-level security driver operable to provide access to the secure partition at a higher privilege level than a file system driver.

9. The apparatus of claim 1, further comprising a security driver at least partly embedded in firmware operable to provide access to the secure partition.

10. The apparatus of claim 1, wherein the secure partition is encrypted.

11. The apparatus of claim 10, wherein the security token comprises a decryption key.

12. The apparatus of claim 10, wherein the security token comprises a shared key.

13. The apparatus of claim 1, wherein the network interface is a wireless network interface operable for operation on an encrypted wireless channel.

14. The apparatus of claim 1, further comprising a firmware operable to perform a security action on the secure partition if the security token expires without being renewed.

15. The apparatus of claim 12, wherein the firmware is embedded in the storage.

16. One or more computer-readable mediums having stored thereon software instructions operable to instruct a processor for:
receiving a security token that corresponds to a location of a storage device; and
applying the security token to a secure partition of the storage to provide access to the secure partition.

17. The one or more mediums of claim 16, further comprising a data structure for correlating access to a plurality of secure partitions to a plurality of locations.

18. The one or more mediums of claim 17, wherein providing access to the secure partitions comprises decrypting the secure partitions.

19. The one or more mediums of claim 16, wherein the security token comprises a decryption key.

20. The one or more mediums of claim 16, wherein the security token comprises a shared key.

21. The one or more mediums of claim 16, wherein the network interface is a wireless network interface operable for operation on an encrypted wireless channel.

22. The one or more mediums of claim 16, wherein the logic is further operable for performing a security action on the secure partition if the security token expires without being renewed.

23. The one or more mediums of claim 22, wherein the logic for performing a security action on the secure partition is resident on the storage.

24. The one or more mediums of claim 16, wherein the logic is further operable for registering upon an apparatus entering a location.

25. The one or more mediums of claim 16, wherein receiving the security token is operable to occur over a radio frequency identification (RFID) device.

26. A secure encryption server comprising:
a network interface; and
logic, at least partly implemented in hardware, operable to:
receive a token request from a device on the network interface;
authenticate a the device;
generate a security token for the device; and
send the security token over the network interface.
